(19) United States
(12) Patent Application Publication
(10) Pub. No.: US 2019/0301542 A1
(43) Pub. Date: Oct. 3, 2019

(54) TRANSFER

(71) Applicant: AISIN AI CO., LTD., Nishio-shi (JP)

(72) Inventors: Terumichi ASAI, Nishio-shi (JP); Shingo TANAKA, Nishio-shi (JP)

(73) Assignee: AISIN AI CO., LTD., Nishio-shi (JP)

(21) Appl. No.: 16/254,900

(22) Filed: Jan. 23, 2019

(30) Foreign Application Priority Data
Mar. 29, 2018 (JP) 2018-066062

(51) Int. Cl. F16D 25/0638; B60K 23/08; B60K 17/34; F16D 48/06

(52) U.S. Cl. CPC F16D 25/0638; B60K 23/0808; B60K 17/34; F16D 48/06; F16D 2500/7041; F16D 2500/1045; F16D 2500/10431; F16D 2500/3026; F16D 2500/1026

(57) ABSTRACT

A wet multi-plate clutch includes: a piston movable between a transmission position where the piston pushes a clutch plate group including a plurality of inside clutch plates supported on an inside cylinder and a plurality of outside clutch plates supported on an outside cylinder, in an axial direction to cause friction between the inside and outside clutch plates, and a disconnection position where the piston is spaced apart from the clutch plate group; and a movable wall configured to move integrally with the piston. The disconnection position includes a first disconnection position and a second disconnection position where the distance between the clutch plate group and the piston is longer than at the first disconnection position. When the piston is positioned at the first disconnection position, a first through hole provided in the inside cylinder and a second through hole provided in the movable wall overlap in the radial direction.

### CROSS-REFERENCE TO RELATED APPLICATIONS

This application is based upon and claims the benefit of priority from Japanese Patent Application No. 2018-066062, filed Mar. 29, 2018, the entire contents of which are incorporated herein by reference.

### FIELD

Embodiments described herein relate generally to a transfer.

### BACKGROUND

Conventionally, a transfer is known which is provided in a four-wheel vehicle and includes a wet multi-plate clutch to switch between a two-wheel drive mode and a four-wheel drive mode (for example, Japanese Patent Application Laid-open No. 2009-197955). In the transfer of this type, when the wet multi-plate clutch is in a transmitted state of transmitting torque, the vehicle is put into the four-wheel drive mode, whereas when the wet multi-plate clutch is in a disconnected state of not transmitting torque, the vehicle is put into the two-wheel drive mode.

In the wet multi-plate clutch in the transfer of this type, when the transmitted state is changed to the disconnected state, pressing between inside clutch plates and outside clutch plates by the piston is released. However, since the inside clutch plates and the outside clutch plates do not have a function to separate from each other, the contact state between the inside clutch plates and the outside clutch plates is kept even after pressing by the piston is released, possibly causing dragging torque between the inside clutch plates and the outside clutch plates. This dragging torque becomes a loss torque in the two-wheel drive mode.

### SUMMARY

One of the problems of the present invention is, for example, to provide a transfer capable of reducing occurrence of dragging torque in a wet multi-plate clutch.

According to one embodiment, a transfer includes a first shaft, a second shaft spaced apart from the first shaft, and a wet multi-plate clutch disposed between the first shaft and the second shaft. The wet multi-plate clutch includes: an inside cylinder formed in a tubular shape around a center axis of the first shaft, the inside cylinder being configured to rotate integrally with the first shaft; an outside cylinder formed in a tubular shape around the center axis and positioned outside in a radial direction of the center axis of the inside cylinder, the outside cylinder being rotatable relative to the first shaft and configured to transmit motive power to the second shaft; a clutch plate group including a plurality of inside clutch plates and a plurality of outside clutch plates, the inside clutch plates being positioned between the inside cylinder and the outside cylinder, the inside clutch plates being supported on the inside cylinder so as to be movable in an axial direction of the center axis and being configured to rotate integrally with the inside cylinder, the outside clutch plates being positioned between the inside cylinder and the outside cylinder, the outside clutch plates being supported on the outside cylinder so as to be movable in the axial direction of the center axis and being configured to rotate integrally with the outside cylinder, the inside clutch plates and the outside clutch plates being alternately positioned in the axial direction of the center axis; a piston configured to be movable in the axial direction relative to the first shaft between a transmission position at which the piston pushes the clutch plate group in the axial direction to cause friction between the inside clutch plates and the outside clutch plates and a disconnection position at which the piston is spaced apart from the clutch plate group; and a movable wall positioned inside in the radial direction of the inside cylinder and configured to move in the axial direction integrally with the piston. The inside cylinder has a first through hole passing through the inside cylinder in the radial direction. The movable wall has a second through hole passing through the movable wall in the radial direction and supplied with oil from inside in the radial direction. The disconnection position includes a first disconnection position and a second disconnection position at which a distance between the clutch plate group and the piston is longer than at the first disconnection position. When the piston is positioned at the transmission position, the first through hole and the second through hole overlap in the radial direction. When the piston is positioned at the first disconnection position, the first through hole and the second through hole overlap in the radial direction. When the piston is positioned at the second disconnection position, the first through hole and the second through hole do not overlap in the radial direction, and the first through hole and a surface on outside in the radial direction of the movable wall overlap in the radial direction.

In the configuration described above, for example, when the piston is positioned at the first disconnection position, the first through hole and the second through hole overlap in the radial direction, so that oil flows from the second through hole to the first through hole and flows in between the inside clutch plates and the outside clutch plates, whereby the inside clutch plates and the outside clutch plates are spaced apart from each other. The dragging torque of the wet multi-plate clutch thus can be reduced.

According to one embodiment, for example, the transfer includes: a drive mechanism configured to move the piston in the axial direction; and a control device configured to control the drive mechanism such that the piston stops at the first disconnection position for a defined time when the piston is moved from the transmission position toward the second disconnection position.

In the configuration described above, when the piston moves from the transmission position toward the second disconnection position, the piston stops at the first disconnection position for a defined time, so that more oil flows from the second through hole to the first through hole and flows in between the inside clutch plates and the outside clutch plates, whereby the inside clutch plates and the outside clutch plates are spaced apart from each other. The dragging torque of the wet multi-plate clutch thus can be reduced more.

According to one embodiment, for example, The piston rotates integrally with the first shaft. One and another of the inside clutch plates are positioned on both ends in the axial direction of the clutch plate group.

In the configuration described above, for example, the piston comes into contact with one of the inside clutch plates, and the piston and the inside clutch plates rotate together integrally with the first shaft. Since there is no differential rotation between the piston and the inside clutch plates, friction heat between the piston and the inside clutch plates can be prevented even when they are in contact with each other.

According to one embodiment, for example, the first disconnection position and the second disconnection position are positions at a first predetermined distance and a second predetermined distance, respectively, from a touch point such that the piston and the clutch plate group are spaced apart from each other, the touch point being a position at which the piston and the clutch plate group come into contact with each other.

According to one embodiment, for example, an amount of overlapping between the first through hole and the second through hole when the piston is positioned at the first disconnection position is smaller than an amount of overlapping between the first through hole and the second through hole when the piston is positioned at the transmission position.

### BRIEF DESCRIPTION OF THE DRAWINGS

FIG. 1 is an illustrative and schematic diagram illustrating an overall configuration of a vehicle in an embodiment;

FIG. 2 is an illustrative and schematic sectional view of part of a transfer in the embodiment in a state in which a piston is positioned at a transmission position;

FIG. 3 is an illustrative and schematic sectional view of part of the transfer in the embodiment in a state in which the piston is positioned at a first disconnection position;

FIG. 4 is an illustrative and schematic sectional view of part of the transfer in the embodiment in a state in which the piston is positioned at a second disconnection position;

FIG. 5 is a diagram as viewed from arrow V in FIG. 2;

FIG. 6 is a diagram as viewed from arrow VI in FIG. 3;

FIG. 7 is a diagram as viewed from arrow VII in FIG. 4; and

FIG. 8 is an illustrative and schematic flowchart illustrating a process executed by an ECU in the embodiment.

### DETAILED DESCRIPTION

Exemplary embodiments of the present invention will be described below. The configuration of the embodiments illustrated below and the operation, result, and effects brought about by the configuration are shown only by way of example. The present invention can be implemented by a configuration other than the one disclosed in the embodiments below. The present invention also can achieve at least one of a variety of effects achieved by the configuration. In the present specification, the ordinal numbers are given for the sake of convenience in order to distinguish parts or sections and are not intended to indicate priority or order.

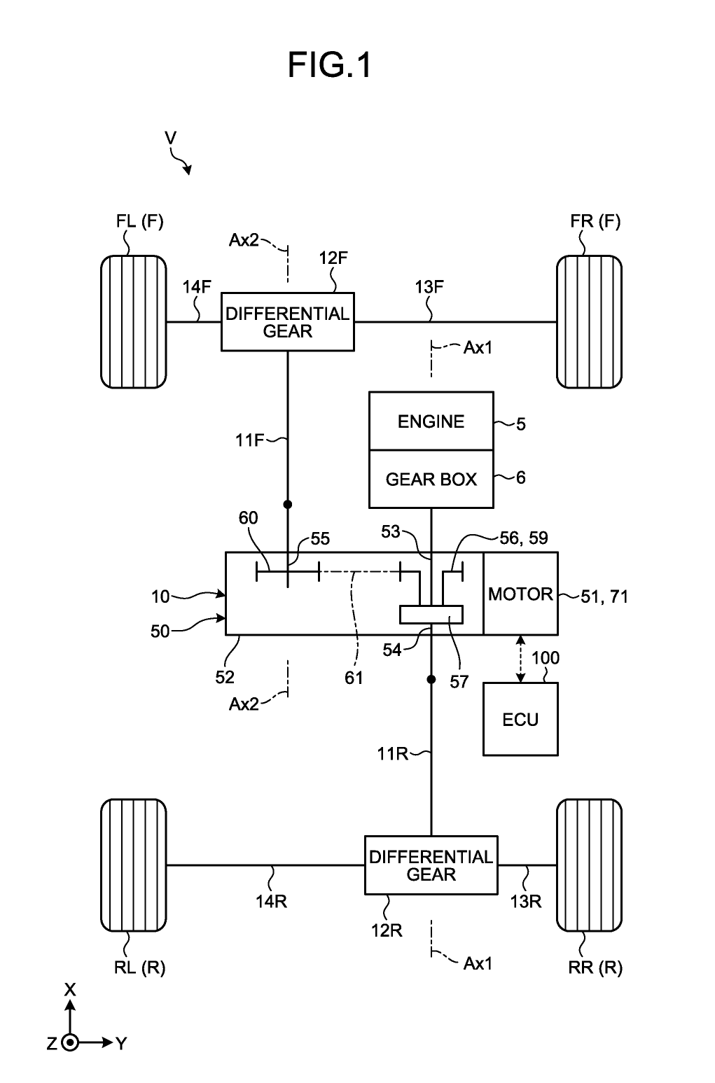

FIG. 1 is an illustrative and schematic diagram illustrating an overall configuration of a vehicle V in the present embodiment. As illustrated in FIG. 1, the vehicle V in the embodiment is configured as a four-wheel automobile having a pair of front wheels F (a left front wheel FL and a right front wheel FR) and a pair of rear wheels R (a left rear wheel RL and a right rear wheel RR). It should be noted that the technique in the embodiment is applicable to any vehicle that has a transfer configured in the same manner as a transfer 10 as will be described below. In the following description, directions are defined for the sake of convenience. The X direction extends along the forward direction in the front-back direction of the vehicle V equipped with the transfer 10. The Y direction extends along the width direction of the vehicle V. The Z direction extends along the upward direction in the up-down direction of the vehicle V. The X direction, the Y direction, and the Z direction are orthogonal to each other.

The vehicle V in the present embodiment includes the transfer 10 for adjusting distribution of torque (motive power) output from an engine 5 to the front wheels F and the rear wheels R and is configured to switch between a four-wheel drive mode and a two-wheel drive mode using the transfer 10. That is, the transfer 10 is configured to be switchable between the four-wheel drive mode in which torque is distributed to four wheels (a pair of front wheels F and a pair of rear wheels R) and the two-wheel drive mode in which torque is distributed only to two wheels (a pair of front wheels F or a pair of rear wheels R) of four wheels. In the two-wheel drive mode in the present embodiment, a pair of rear wheels R are driven, by way of example. However, a pair of front wheels F may be driven in the two-wheel drive mode.

A gear box 6 is provided on a power transmission path between the transfer 10 and the engine 5. A propeller shaft 11F on the front wheel F side and a differential gear 12F on the front wheel F side are provided on a power transmission path between the transfer 10 and a pair of front wheels F. A propeller shaft 11R on the rear wheel R side and a differential gear 12R on the rear wheel R side are provided on a power transmission path between the transfer 10 and a pair of rear wheels R.

The differential gear 12F distributes torque input through the propeller shaft 11F to the right front wheel FR connected to an axle 13F and to the left front wheel FL connected to an axle 14F. Similarly, the differential gear 12R distributes torque input through the propeller shaft 11R to the right rear wheel RR connected to an axle 13R and to the left rear wheel RL connected to an axle 14R.

In such a configuration, in the two-wheel drive mode, the transfer 10 outputs torque to a pair of rear wheels R and does not output torque to a pair of front wheels F. The torque output from the transfer 10 in the two-wheel drive mode is appropriately distributed to the right rear wheel RR and the left rear wheel RL through the propeller shaft 11R on the rear wheel R side, the differential gear 12R on the rear wheel R side, and the axles 13R and 14R. By contrast, in the four-wheel drive mode, the transfer 10 outputs torque to both of a pair of front wheels F and a pair of rear wheels R. Part of the torque output from the transfer 10 in the four-wheel drive mode is appropriately distributed to the right rear wheel RR and the left rear wheel RL through the propeller shaft 11R on the rear wheel R side, the differential gear 12R on the rear wheel R side, and the axles 13R and 14R, in the same manner as in the two-wheel drive mode. Another part of the torque output from the transfer 10 in the four-wheel drive mode is appropriately distributed to the right front wheel FR and the left front wheel FL through the propeller shaft 11F on the front wheel F side, the differential gear 12F on the front wheel F side, and the axles 13F and 14F.

The transfer 10 will now be described in detail. The transfer 10 includes a mechanical part 50 and a motor 51 configured to drive the mechanical part 50. The motor 51 is an example of a drive source.

The mechanical part 50 includes a case 52, an input shaft 53, two output shafts 54 and 55, a transmission part 56, and a wet multi-plate clutch 57. The output shaft 54 is an example of the first shaft, and the output shaft 55 is an example of the second shaft.

The case 52 accommodates the input shaft 53, two output shafts 54 and 55, the transmission part 56, and the wet multi-plate clutch 57. The case 52 is supported on the body of the vehicle V.

The input shaft 53 is supported by the case 52 so as to be rotatable about a center axis Ax1 along the vehicle front-back direction. The front-side end of the input shaft 53 is connected to the engine 5 through the gear box 6 so that torque (motive power) of the engine 5 is input to the input shaft 53.

The output shaft 54 is connected to the rear-side end of the input shaft 53 and rotates about the center axis Ax integrally with the input shaft 53. The rear-side end of the output shaft 54 is connected to the propeller shaft 11R.

The output shaft 55 is provided apart from the output shaft 54. Specifically, the output shaft 55 is arranged at a distance from the output shaft 54 in the Y direction. The output shaft 55 is provided in parallel with the output shaft 54. The output shaft 55 is supported by the case 52 so as to be rotatable about the center axis Ax2 parallel to the center axis Ax1 along the vehicle front-back direction.

The transmission part 56 includes two sprockets 59 and 60 and a chain belt 61. One sprocket 59 is provided on the output shaft 54. The sprocket 59 is supported on the output shaft 54 so as to be rotatable relative to the output shaft 54. The sprocket 59 is coupled to the output shaft 54 such that it is rotated integrally with the output shaft 54 by the wet multi-plate clutch 57. This coupled state of the sprocket 60 to the output shaft 54 may be referred to as integrally rotating state. The state in which the sprocket 59 is not coupled to the output shaft 54 by the wet multi-plate clutch 57, that is, the state in which the sprocket 59 is rotatable relative to the output shaft 54 may be referred to as relatively rotatable state.

The other sprocket 60 is provided on the output shaft 55. The sprocket 60 is fixed to the output shaft 55 and rotates integrally with the output shaft 55. The chain belt 61 is stretched between two sprockets 59 and 60.

The transmission part 56 having the configuration above transmits torque (motive power) of the output shaft 54 to the output shaft 55 through the sprocket 59, the chain belt 61, and the sprocket 60 when the sprocket 59 is in the integrally rotatable state. The output shaft 55 thus rotates. By contrast, when the sprocket 59 is in the relatively rotatable state, the sprocket 59 rotates relative to the output shaft 54 and therefore torque of the output shaft 54 is not transmitted to the output shaft 55.

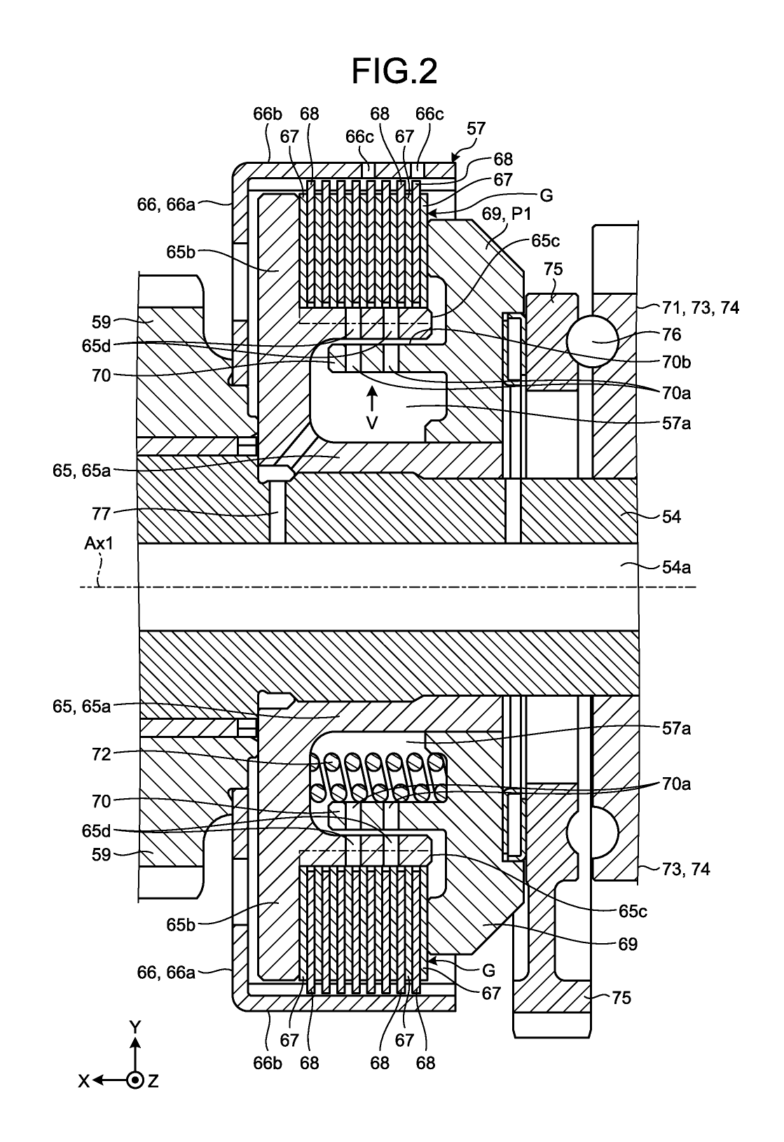

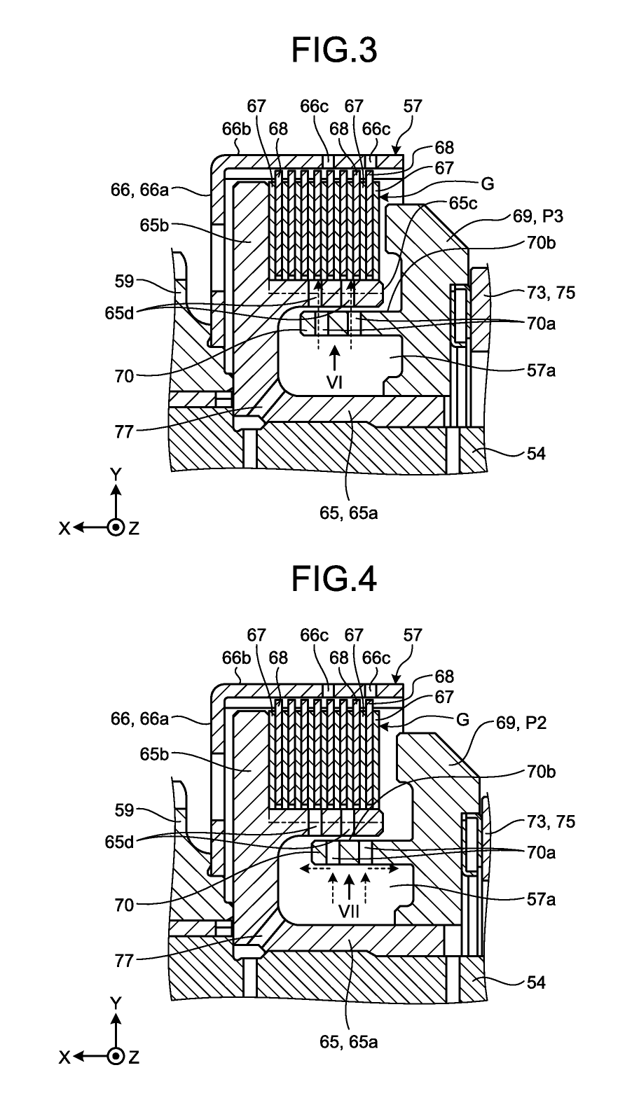

FIGS. 2 to 4 are illustrative and schematic sectional views illustrating part of the transfer 10. FIG. 2 is a sectional view in a state in which a piston 69 is positioned at a transmission position P1. FIG. 3 is a sectional view in a state in which the piston 69 is positioned at a first disconnection position P3. FIG. 4 is a sectional view in a state in which the piston 69 is positioned at a second disconnection position P2. In the following, the axial direction, the radial direction, and the circumferential direction are the axial direction, the radial direction, and the circumferential direction, respectively, of the center axis Ax1 of the output shaft 54, unless otherwise specified.

As illustrated in FIG. 2, the wet multi-plate clutch 57 is provided between the output shaft 54 and the output shaft 55 and interposed between the output shaft 54 and the output shaft 55. As illustrated in FIGS. 2 to 4, the wet multi-plate clutch 57 switches between a transmitted state (FIG. 2) in which motive power is transmitted between the output shaft 54 and the output shaft 55 by friction and a second disconnected state (FIG. 4) in which motive power is not transmitted between the output shaft 54 and the output shaft 55, through a first disconnected state (FIG. 3). The first disconnected state may be referred to as half disengaged state or intermediate state.

As illustrated in FIG. 2, the wet multi-plate clutch 57 includes an inside drum 65, an outside drum 66, a plurality of inside clutch plates 67, a plurality of outside clutch plates 68, a piston 69, and a movable wall 70.

The inside drum 65 is fixed to the output shaft 54 and rotates about the center axis Ax1 integrally with the output shaft 54. The inside drum 65 has a hub 65a, a wall 65b, and an inside cylinder 65c.

The hub 65a is formed in a cylindrical shape around the center axis Ax1 and fixed to the output shaft 54. The wall 65b is formed in an annular shape extending in the radial direction from an end on one side (the X direction) in the axial direction of the hub 65a.

The inside cylinder 65c extends from an intermediate portion in the radial direction of the wall 65b to the other side (the opposite direction in the X direction) in the axial direction. The inside cylinder 65c is formed in a cylindrical shape around the center axis Ax1. The inside cylinder 65c is fixed to the output shaft 54 with the wall 65b and the hub 65a interposed and rotates integrally with the output shaft 54. A chamber 57a is formed between the inside cylinder 65c and the hub 65a.

The inside cylinder 65c has a plurality of first through holes 65d passing through the inside cylinder 65c in the radial direction. In the present embodiment, a plurality of first through holes 65d at a distance from each other in the circumferential direction forms a row, and a plurality of rows of first through holes 65d in the circumferential direction are provided at a distance from each other in the axial direction. Each of the first through holes 65d is formed, for example, in a circular shape in cross section. The number, arrangement, and shape of the first through holes 65d are not limited to the example in FIG. 2.

The outside drum 66 is supported on the output shaft 54 with the sprocket 59 interposed so as to be rotatable relative to the output shaft 54. The outside drum 66 is fixed to the sprocket 59 and rotates about the center axis Ax1 integrally with the sprocket 59. The outside drum 66 transmits torque (motive power) to the output shaft 55 through the transmission part 56.

The outside drum 66 has a wall 66a and an outside cylinder 66b. The wall 66a is formed in an annular shape extending in the radial direction from an end on the other side in the axial direction of the sprocket 59 and fixed to the sprocket 59.

The outside cylinder 66b is formed in a cylindrical shape around the center axis Ax1. The outside cylinder 66b extends from an end on the outside in the radial direction of the wall 66a to the other side in the axial direction (the opposite direction to the X direction). The outside cylinder 66b is positioned on the outside in the radial direction of the inside cylinder 65c and opposed to the inside cylinder 65c in the radial direction. The outside cylinder 66b is supported on the output shaft 54 with the wall 66a and the sprocket 59 interposed so as to be rotatable relative to the output shaft 54. The outside cylinder 66b has a plurality of through holes 66c passing through the outside cylinder 66b in the radial direction.

The inside clutch plates 67 are formed in an annular shape around the center axis Ax1. The inside clutch plates 67 are positioned between the inside cylinder 65c and the outside cylinder 66b and arranged at a distance from each other in the axial direction. The inside clutch plates 67 are supported on the inside cylinder 65c so as to be movable in the axial direction and rotate integrally with the inside cylinder 65c. Specifically, the inside clutch plates 67 are splined to the outer peripheral portion of the inside cylinder 65c.

The outside clutch plates 68 are formed in an annular shape around the center axis Ax1. The outside clutch plates 68 are positioned between the inside cylinder 65c and the outside cylinder 66b and arranged at a distance from each other in the axial direction. The outside clutch plates 68 are supported on the outside cylinder 66b so as to be movable in the axial direction and rotate integrally with the outside cylinder 66b. Specifically, the outside clutch plates 68 are splined to the inner peripheral portion of the outside cylinder 66b.

The inside clutch plates 67 and the outside clutch plates 68 are alternately positioned in the axial direction. The inside clutch plates 67 and the outside clutch plates 68 form a clutch plate group G. One and another of the inside clutch plates 67 are positioned on both ends in the axial direction of the clutch plate group G.

The piston 69 is positioned on the other side (the opposite side in the X direction) in the axial direction of the clutch plate group G. The piston 69 is formed in an annular shape around the center axis Ax1. The piston 69 is supported on the inside drum 65 so as to be movable in the axial direction relative to the inside drum 65 and the output shaft 54 and rotates integrally with the inside drum 65. Specifically, the piston 69 is splined to the hub 65a of the inside drum 65.

The movable wall 70 is provided integrally with the piston 69. The movable wall 70 is formed in a cylindrical shape around the center axis Ax1. The movable wall 70 extends from the piston 69 to one side (the X direction) in the axial direction. The movable wall 70 is positioned on the inside in the radial direction of the inside cylinder 65c and is overlapped with the inside cylinder 65c with a gap. The movable wall 70 is movable in the axial direction together with the piston 69. The movable wall 70 may be referred to as cover.

The movable wall 70 has a plurality of second through holes 70a passing through the movable wall 70 in the radial direction and supplied with oil from the inside in the radial direction. In the present embodiment, a plurality of second through holes 70a are arranged in the same manner as a plurality of first through holes 65d. That is, a plurality of second through holes 70a are arranged at a distance from each other in the circumferential direction to form a row, and a plurality of rows of the second through holes 70a in the circumferential direction are provided at a distance from each other in the axial direction. Each of the second through holes 70a is formed, for example, in a circular shape in cross section. The number, arrangement, and shape of the second through holes 70a are not limited to the example in FIG. 2.

As illustrated in FIGS. 2 to 4, the piston 69 is movable in the axial direction relative to the output shaft 54 between the transmission position P1 (FIG. 2) and the second disconnection position P2 (FIG. 4). The first disconnection position P3 (FIG. 3) is between the transmission position P1 and the second disconnection position P2, and the first disconnection position P3 and the second disconnection position P2 are included in the disconnection position. The transmission position P1 may be referred to as connection position. The first disconnection position P3 may be referred to as half disengaged position or intermediate position, and the second disconnection position P2 may be referred to as disengaged position.

The transmission position P1 illustrated in FIG. 2 is a position at which the piston 69 pushes the clutch plate group G to one side (the X direction) in the axial direction to cause friction between the inside clutch plates 67 and the outside clutch plates 68. Here, the clutch plate group G is pressed against the wall 65b of the inside drum 65 by the piston 69. That is, the clutch plate group G is sandwiched between the piston 69 and the wall 65b. In a state in which the piston 69 is positioned at the transmission position P1, the inside clutch plates 67 and the outside clutch plates 68 integrally rotate by friction. The sprocket 60 then rotates integrally with the output shaft 54 so that the torque of the input shaft 53 is transmitted to the output shaft 55 through the wet multi-plate clutch 57 and the transmission part 56.

The first disconnection position P3 illustrated in FIG. 3 and the second disconnection position P2 illustrated in FIG. 4 are positions at which the piston 69 is spaced apart from the clutch plate group G, that is, positions on the other side (the position on the opposite side in the X direction) in the axial direction of the transmission position P1. In the second disconnection position P2, the distance between the clutch plate group G and the piston 69 is longer than in the first disconnection position P3. The first disconnection position P3 and the second disconnection position P2 are positions at a first predetermined distance and a second predetermined distance, respectively, from a touch point such that the piston 69 and the clutch plate group G are spaced apart from each other. The second predetermined distance is longer than the first predetermined distance. The touch point is a point (position) at which the piston 12 and the clutch plate group G come into contact with each other. When the piston 69 is positioned at the touch point, there is no gap (no clearance) between the inside clutch plates 67 and the outside clutch plates 68.

In the first disconnection position P3 and the second disconnection position P2, the piston 69 does not push the clutch plate group G in the axial direction and does not cause friction between the inside clutch plates 67 and the outside clutch plates 68. In a state in which the piston 69 is positioned at the first disconnection position P3 or the second disconnection position P2, the inside clutch plates 67 and the outside clutch plates 68 are spaced apart in the axial direction, so that the inside clutch plates 67 and the outside clutch plates 68 can rotate relative to each other. The sprocket 60 and the output shaft 54 thus rotate relatively, and therefore the torque of the input shaft 53 is not transmitted to the output shaft 55. In FIGS. 3 and 4, the gaps between the inside clutch plates 67 and the outside clutch plates 68 are omitted. The piston 69 passes through the first disconnection position P3 during the course of moving between the transmission position P1 and the second disconnection position P2.

As illustrated in FIGS. 2 to 4, the piston 69 is moved in the axial direction by a drive mechanism 71.

As illustrated in FIG. 2, the drive mechanism 71 includes an elastic member 72, a cam mechanism 73, and the motor 51 (FIG. 1).

The elastic member 72 accommodated in the chamber 57a is interposed between the wall 65b of the inside drum 65 and the piston 69. The elastic member 72 is, for example, a coil spring. The elastic member 72 operates as a compression spring that produces an elastic force to push the piston 69 in the direction from the transmission position P1 to the second disconnection position P2.

The cam mechanism 73 is a ball cam mechanism including a fixed cam plate 74, a movable cam plate 75, and a ball 76. The fixed cam plate 74 and the movable cam plate 75 are formed in an annular shape around the center axis Ax1 and provided so as to be rotatable relative to the output shaft 54. The rotation of the fixed cam plate 74 about the center axis Ax1 is restricted by a not-illustrated stopper. The movable cam plate 75 is provided so as to be movable relative to the output shaft 54 and the fixed cam plate 74 in the axial direction. The ball 76 is sandwiched between a pair of cam surfaces provided on the fixed cam plate 74 and the movable cam plate 75. The movable cam plate 75 is connected to the motor 51 through a not-illustrated gear mechanism and is rotated about the center axis Ax1 by the driving force of the motor 51. The movable cam plate 75 faces the piston 69 in the axial direction and can push the piston 69 to one side (the X direction) in the axial direction.

In the drive mechanism 71 having the configuration above, when the movable cam plate 75 is rotated by the motor 51 in one direction (transmission rotating direction) about the center axis Ax1, the movable cam plate 75 moves against the elastic force of the elastic member 72 while pushing the piston 69 in one direction (the X direction) in the axial direction. The piston 69 is thus moved toward the transmission position P1. By contrast, when the movable cam plate 75 is rotated by the motor 51 in the other direction (disconnection rotating direction) about the center axis Ax1, the movable cam plate 75 is moved by the elastic force of the elastic member 72 together with the piston 69 in the other direction (the opposite direction in the X direction) in the axial direction. The piston 69 is thus moved toward the second disconnection position P2.

An oil (lubricating oil) supplying structure of the wet multi-plate clutch 57 will now be described. The wet multi-plate clutch 57 is supplied with oil by a not-illustrated pump. The pump is connected to the output shaft 54 through a not-illustrated gear and operates with rotation of the output shaft 54. The pump sucks up oil stored at the bottom of the case 52 and supplies the oil to a channel 54a (FIG. 2) provided in the output shaft 54. As illustrated in FIG. 2, the oil supplied to the channel 54a flows into the chamber 57a through a channel 77 provided across the output shaft 54 and the inside drum 65. For example, when the piston 69 is positioned at the transmission position P1, the oil in the chamber 57a passes through the second through holes 70a in the movable wall 70 and the first through holes 65d in the inside cylinder 65c, flows between the inside cylinder 65c and the outside cylinder 66b, and then flows out through the through holes 66c in the outside cylinder 66b. The oil flowing out through the through holes 66c flows to the bottom of the case 52.

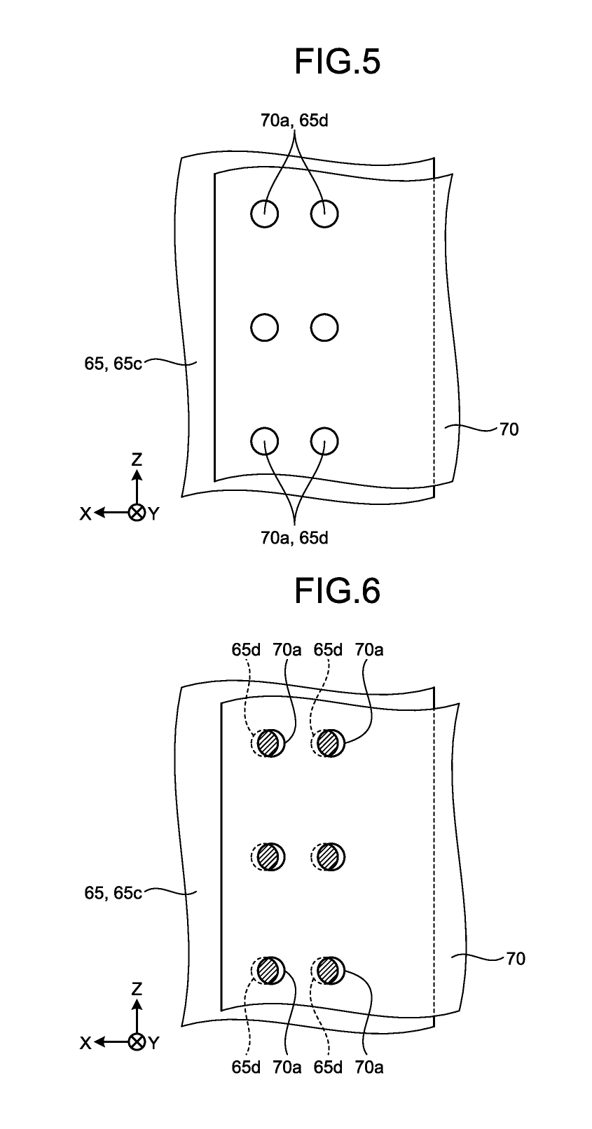

FIG. 5 is a diagram as viewed from arrow V in FIG. 2. As illustrated in FIGS. 2 and 5, when the piston 69 is positioned at the transmission position P1, the first through hole 65d in the inside cylinder 65c and the second through hole 70a in the movable wall 70 overlap in the radial direction. In other words, when the piston 69 is positioned at the transmission position P1, the first through hole 65d in the inside cylinder 65c and the second through hole 70a in the movable wall 70 are aligned in the radial direction. Consequently, as described above, the oil in the chamber 57a passes through the second through holes 70a in the movable wall 70 and the first through holes 65d in the inside cylinder 65c and flows between the inside cylinder 65c and the outside cylinder 66b. The oil is thus supplied to the inside clutch plates 67 and the outside clutch plates 68.

FIG. 6 is a diagram as viewed from arrow VI in FIG. 3. As illustrated in FIGS. 3 and 6, when the piston 69 is positioned at the first disconnection position P3 that is a position between the transmission position P1 and the second disconnection position P2, the first through holes 65d and the second through holes 70a overlap (are aligned) in the radial direction. In the present embodiment, when the piston 69 is positioned at the first disconnection position P3, part of the first through hole 65d and part of the second through hole 70a overlap in the radial direction, and the amount of overlapping between the first through hole 65d and the second through hole 70a is smaller when the piston 69 is positioned at the first disconnection position P3 than when the piston 69 is positioned at the transmission position P1. Oil is thus supplied to the inside clutch plates 67 and the outside clutch plates 68, and oil flows in between the inside clutch plates 67 and the outside clutch plates 68, so that the inside clutch plates 67 and the outside clutch plates 68 are spaced apart from each other. In FIG. 6, the overlap portion between part of the first through hole 65d and part of the second through hole 70a is hatched.

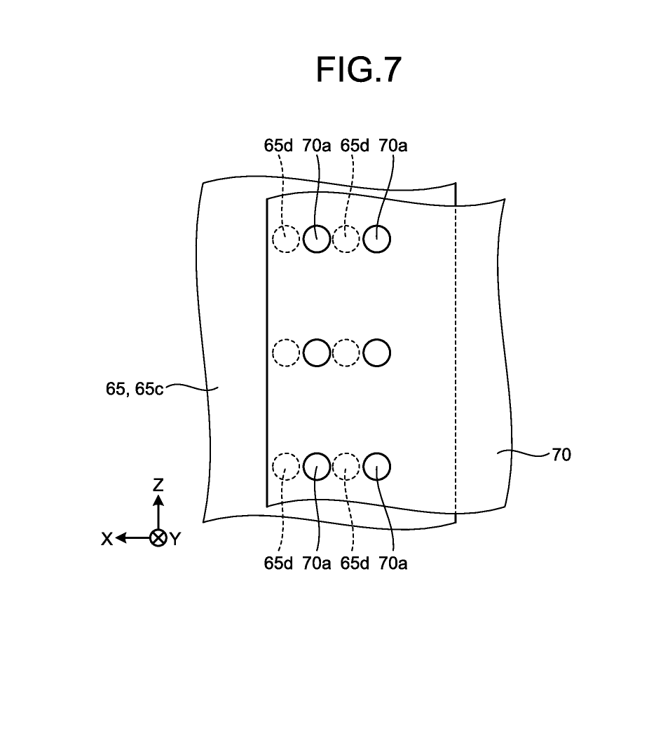

FIG. 7 is a diagram as viewed from arrow VII in FIG. 4. As illustrated in FIGS. 4 and 7, when the piston 69 is positioned at the second disconnection position P2, the first through hole 65d and the second through hole 70a do not overlap (are not aligned) in the radial direction, and the first through hole 65d overlaps an outer peripheral surface 70b of the movable wall 70 in the radial direction. That is, the radially inside of the first through hole 65d is covered with the outer peripheral surface 70b. The inflow of oil in the chamber 57a to the first through holes 65d in the inside cylinder 65c is restricted, and, consequently, the inflow of oil between the inside cylinder 65c and the outside cylinder 66b is restricted. The outer peripheral surface 70b is an example of the surface on the outside in the radial direction of the movable wall 70.

An electronic control unit (ECU) 100 illustrated in FIG. 1 is configured as a microcomputer having a hardware configuration including a processor and a memory. In the ECU 100, the processor reads and executes a predetermined control program stored in the memory to implement a variety of functions. For example, the ECU 100 switches the transmitted state and the disconnected state of the wet multi-plate clutch 57 by controlling the motor 51 in response to a switching signal indicating switching between two-wheel drive and four-wheel drive from an operation unit in accordance with the driver's operation. The ECU 100 is an example of the control device. The functions of the control device may be partially or entirely implemented by hardware (circuitry) other than a microcomputer.

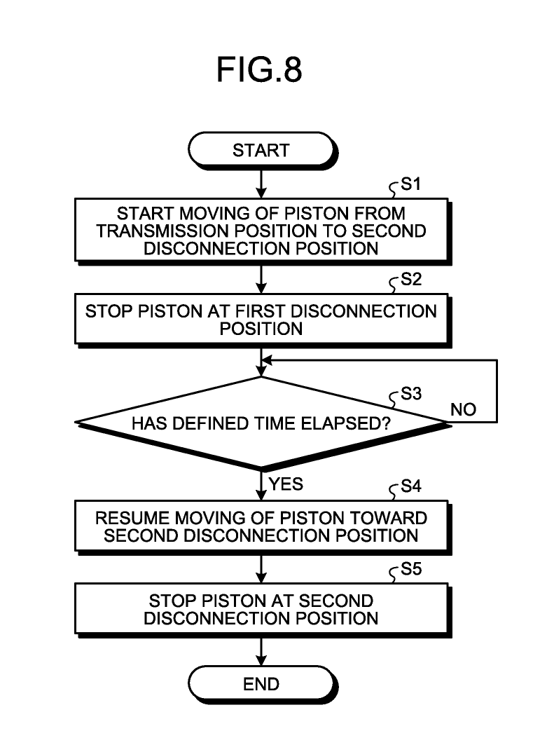

FIG. 8 is an illustrative and schematic flowchart illustrating the process executed by the ECU 100 in the present embodiment. The switching process from four-wheel drive to two-wheel drive that is executed by the ECU 100 will be described based on FIG. 8.

When a switching signal from four-wheel drive to two-wheel drive is input, the ECU 100 controls the motor 51 to start moving of the piston 69 and the movable wall 70 from the transmission position P1 to the second disconnection position P2 (step S1).

Next, the ECU 100 controls the motor 51 such that the piston 69 stops at the first disconnection position P3 (step S2). The stopping of the piston 69 at the first disconnection position P3 may be done by controlling the rotation angle of the motor 51 or may be done using a detection result of a sensor that detects the position of the piston 69. The ECU 100 then waits until a defined time has elapsed (No at step S3). The defined time may be preset as appropriate. If a defined time has elapsed (Yes at step S3), the ECU 100 controls the motor 51 to resume the moving of the piston 69 and the movable wall 70 to the second disconnection position P2 (step S4). Subsequently, the ECU 100 controls the motor 51 such that the piston 69 and the movable wall 70 stop at the second disconnection position P2 (step S5).

As described above, in the present embodiment, when the piston 69 is positioned at the first disconnection position P3 between the transmission position P1 and the second disconnection position P2 in the wet multi-plate clutch 57, the first through hole 65d (first through hole) and the second through hole 70a (second through hole) overlap in the radial direction. Therefore, according to the present embodiment, when the piston 69 is positioned at the first disconnection position P3, oil flows from the second through holes 70a to the first through holes 65d and flows in between the inside clutch plates 67 and the outside clutch plates 68, whereby the inside clutch plates 67 and the outside clutch plates are spaced apart from each other. The dragging torque of the wet multi-plate clutch 57 thus can be reduced. Accordingly, the transmission efficiency of torque to the rear wheels R in the two-wheel drive mode is improved.

In the present embodiment, when the piston 69 is moved from the transmission position P1 toward the second disconnection position P2, the ECU 100 controls the drive mechanism 71 such that the piston 69 stops at the first disconnection position P3 for a defined time. Therefore, according to the present embodiment, when the piston 69 moves from the transmission position P1 toward the second disconnection position P2, more oil flows from the second through holes 70a to the first through holes 65d and flows in between the inside clutch plates 67 and the outside clutch plates 68, compared with when the piston 69 does not stop at the first disconnection position P3, whereby the inside clutch plates 67 and the outside clutch plates are spaced apart from each other. The dragging torque of the wet multi-plate clutch 57 thus can be reduced more.

In the present embodiment, the piston 69 rotates integrally with the output shaft 54 (first shaft). The inside clutch plates 67 are positioned on both ends of the clutch plate group G. Therefore, according to the present embodiment, for example, the piston 69 comes into contact with one of the inside clutch plates 67, and the piston 69 and the inside clutch plates 67 rotate together integrally with the output shaft 54. Since there is no differential rotation between the piston 69 and the inside clutch plates 67, friction heat between the piston 69 and the inside clutch plates 67 can be prevented even when they are in contact with each other.

In the foregoing embodiment, the ECU 100 stops the piston 69 at the first disconnection position P3. However, embodiments are not limited to this example. The ECU 100 may control the motor 51 such that the piston 69 continuously moves without stopping between the transmission position P1 and the second disconnection position P2.

The diameter of the second through hole 70a may be larger than the diameter of the first through hole 65d. The second through hole 70a may be a hole elongated in the center axis Ax1 direction. By doing so, for example, even when the inside clutch plates 67 and/or the outside clutch plates 68 wear out, the suitable amount of oil can be kept in the transmitted state of the wet multi-plate clutch 57.

In the present embodiment, the piston 69 rotates integrally with the output shaft 54 (first shaft). However, embodiments are not limited to this example. The piston 69 may be provided so as to be rotatable relative to the output shaft 54. In this case, since the piston 69 and the movable wall 70 rotate relative to the inside drum 65, the first through holes 65d and the second through holes 70a also rotate relatively. Then, in this case, the shape and the size of the first through holes 65d and the second through holes 70a are set such that the first through hole 65d and the second through hole 70a at least partially overlap each other in the radial direction when the piston 69 is positioned at the transmission position P1 or the first disconnection position P3 even if the first through holes 65d and the second through holes 70a rotate relatively. For example, the first through holes 65d and the second through holes 70a may be formed as elongated holes extending in the circumferential direction.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A transfer comprising:
a first shaft;
a second shaft spaced apart from the first shaft; and
a wet multi-plate clutch disposed between the first shaft and the second shaft, wherein
the wet multi-plate clutch includes:
an inside cylinder formed in a tubular shape around a center axis of the first shaft, the inside cylinder being configured to rotate integrally with the first shaft;
an outside cylinder formed in a tubular shape around the center axis and positioned outside in a radial direction of the center axis of the inside cylinder, the outside cylinder being rotatable relative to the first shaft and configured to transmit motive power to the second shaft;
a clutch plate group including a plurality of inside clutch plates and a plurality of outside clutch plates, the inside clutch plates being positioned between the inside cylinder and the outside cylinder, the inside clutch plates being supported on the inside cylinder so as to be movable in an axial direction of the center axis and being configured to rotate integrally with the inside cylinder, the outside clutch plates being positioned between the inside cylinder and the outside cylinder, the outside clutch plates being supported on the outside cylinder so as to be movable in the axial direction of the center axis and being configured to rotate integrally with the outside cylinder, the inside clutch plates and the outside clutch plates being alternately positioned in the axial direction of the center axis;
a piston configured to be movable in the axial direction relative to the first shaft between a transmission position at which the piston pushes the clutch plate group in the axial direction to cause friction between the inside clutch plates and the outside clutch plates and a disconnection position at which the piston is spaced apart from the clutch plate group; and
a movable wall positioned inside in the radial direction of the inside cylinder and configured to move in the axial direction integrally with the piston, wherein
the inside cylinder has a first through hole passing through the inside cylinder in the radial direction,
the movable wall has a second through hole passing through the movable wall in the radial direction and supplied with oil from inside in the radial direction,
the disconnection position includes a first disconnection position and a second disconnection position at which a distance between the clutch plate group and the piston is longer than at the first disconnection position,
when the piston is positioned at the transmission position, the first through hole and the second through hole overlap in the radial direction,
when the piston is positioned at the first disconnection position, the first through hole and the second through hole overlap in the radial direction, and
when the piston is positioned at the second disconnection position, the first through hole and the second through hole do not overlap in the radial direction, and the first through hole and a surface on outside in the radial direction of the movable wall overlap in the radial direction.

2. The transfer according to claim 1, further comprising:
a drive mechanism configured to move the piston in the axial direction; and
a control device configured to control the drive mechanism such that the piston stops at the first disconnection position for a defined time when the piston is moved from the transmission position toward the second disconnection position.

3. The transfer according to claim 1, wherein
the piston rotates integrally with the first shaft, and
one and another of the inside clutch plates are positioned on both ends in the axial direction of the clutch plate group.

4. The transfer according to claim 2, wherein
the piston rotates integrally with the first shaft, and
one and another of the inside clutch plates are positioned on both ends in the axial direction of the clutch plate group.

5. The transfer according to claim 1, wherein
the first disconnection position and the second disconnection position are positions at a first predetermined distance and a second predetermined distance, respectively, from a touch point such that the piston and the clutch plate group are spaced apart from each other, the touch point being a position at which the piston and the clutch plate group come into contact with each other.

6. The transfer according to claim 2, wherein
the first disconnection position and the second disconnection position are positions at a first predetermined distance and a second predetermined distance, respectively, from a touch point such that the piston and the clutch plate group are spaced apart from each other, the touch point being a position at which the piston and the clutch plate group come into contact with each other.

7. The transfer according to claim 3, wherein
the first disconnection position and the second disconnection position are positions at a first predetermined distance and a second predetermined distance, respectively, from a touch point such that the piston and the clutch plate group are spaced apart from each other, the touch point being a position at which the piston and the clutch plate group come into contact with each other.

8. The transfer according to claim 4, wherein
the first disconnection position and the second disconnection position are positions at a first predetermined distance and a second predetermined distance, respectively, from a touch point such that the piston and the clutch plate group are spaced apart from each other, the touch point being a position at which the piston and the clutch plate group come into contact with each other.

9. The transfer according to claim 1, wherein
an amount of overlapping between the first through hole and the second through hole when the piston is positioned at the first disconnection position is smaller than an amount of overlapping between the first through hole and the second through hole when the piston is positioned at the transmission position.

10. The transfer according to claim 2, wherein
an amount of overlapping between the first through hole and the second through hole when the piston is positioned at the first disconnection position is smaller than an amount of overlapping between the first through hole and the second through hole when the piston is positioned at the transmission position.

11. The transfer according to claim 3, wherein
an amount of overlapping between the first through hole and the second through hole when the piston is positioned at the first disconnection position is smaller than an amount of overlapping between the first through hole and the second through hole when the piston is positioned at the transmission position.

12. The transfer according to claim 4, wherein
an amount of overlapping between the first through hole and the second through hole when the piston is positioned at the first disconnection position is smaller than an amount of overlapping between the first through hole and the second through hole when the piston is positioned at the transmission position.

13. The transfer according to claim 5, wherein
an amount of overlapping between the first through hole and the second through hole when the piston is positioned at the first disconnection position is smaller than an amount of overlapping between the first through hole and the second through hole when the piston is positioned at the transmission position.

14. The transfer according to claim 6, wherein
an amount of overlapping between the first through hole and the second through hole when the piston is positioned at the first disconnection position is smaller than an amount of overlapping between the first through hole and the second through hole when the piston is positioned at the transmission position.

15. The transfer according to claim 7, wherein
an amount of overlapping between the first through hole and the second through hole when the piston is positioned at the first disconnection position is smaller than an amount of overlapping between the first through hole and the second through hole when the piston is positioned at the transmission position.

16. The transfer according to claim 8, wherein
an amount of overlapping between the first through hole and the second through hole when the piston is positioned at the first disconnection position is smaller than an amount of overlapping between the first through hole and the second through hole when the piston is positioned at the transmission position.
